(19) United States
(12) Patent Application Publication
(10) Pub. No.: US 2002/0064702 A1
(43) Pub. Date: May 30, 2002

(54) Fuel cell fluid flow field plate and methods of making fuel cell flow field plates

(76) Inventor: Peter R. Gibb, Coquitlam (CA)

Correspondence Address: Robert W. Fieseler, McAndrews, Held & Malloy, Ltd., 500 West Madison Street, 34th Floor, Chicago, IL, 60661, US

(21) Appl. No.: 09/999,510

(22) Filed: Oct. 19, 2001

Related U.S. Application Data
(63) Continuation of application No. 09/223,356, filed on Dec. 30, 1998, now abandoned.

(51) Int. Cl. H01M 8/02

(52) U.S. Cl. 429/34; 429/39; 264/293; 264/331.11; 264/319

(57) ABSTRACT

An electrically conductive, fuel cell fluid flow field plate comprises a first major surface, a second major surface disposed opposite said first major surface, and a plurality of parallel substantially straight channels formed in at least one of the first and second major surfaces. The channels are separated by lands, and at least one of the plurality of channels has an open width less than about 0.75 millimeter. The channels preferably have a length to cross sectional area ratio of between about 2180:1 to about 6200:1. When the fluid flow field plate is used in a fuel cell operating at a current density higher than about 500 mA/cm², the pressure differential between the inlets and outlets of the oxidant flow field channels is between about 138 millibars and about 400 millibars. Such fluid flow field plates may be formed by embossing or molding.

### CROSS-REFERENCE TO RELATED APPLICATION(S)

The present application is a continuation of U.S. patent application Ser. No. 09,223,356 filed Dec. 30, 1998 entitled “Fuel Cell Fluid Flow Field Plate and Methods of Making Fuel Cell Flow Field Plates”, which is hereby incorporated by reference herein in its entirety.

### FIELD OF THE INVENTION

The present invention relates to a fluid flow field plate for a fuel cell and methods of making fuel cell flow field plates. More particularly, the invention relates to a fuel cell fluid flow field plate comprising a plurality of substantially straight parallel elongated fluid flow field channels for directing at least one reactant and/or coolant fluid stream within a fuel cell.

### BACKGROUND OF THE INVENTION

Electrochemical fuel cells convert reactants, namely fuel and oxidants, to generate electric power and reaction products. Electrochemical fuel cells generally employ an electrolyte disposed between two electrodes, namely a cathode and an anode. The electrodes each comprise an electrocatalyst disposed at the interface between the electrolyte and the electrodes to induce the desired electrochemical reactions. The fuel fluid stream which is supplied to the anode may be a gas such as substantially pure hydrogen or a reformate stream comprising hydrogen. Alternatively, a liquid fuel stream such as, for example, aqueous methanol may be used. The oxidant fluid stream, which is supplied to the cathode, typically comprises oxygen, such as substantially pure oxygen, or a dilute oxygen stream such as air.

Solid polymer fuel cells employ a solid polymer electrolyte, or ion exchange membrane. The membrane is typically interposed between two electrode layers, forming a membrane electrode assembly (“MEA”). While the membrane is typically proton conductive, it also acts as a barrier, isolating the fuel and oxidant streams from each other on opposite sides of the MEA. The MEA is typically disposed between two plates to form a fuel cell assembly. The plates act as current collectors and provide support for the adjacent electrodes. The assembly is typically compressed to ensure good electrical contact between the plates and the electrodes, in addition to good sealing between fuel cell components. A plurality of fuel cell assemblies may be combined in series or in parallel to form a fuel cell stack. In a fuel cell stack, a plate may be shared between two adjacent fuel cell assemblies, in which case the plate also serves as a separator to fluidly isolate the fluid streams of the two adjacent fuel cell assemblies.

Fuel cell plates known as fluid flow field plates have open channels formed in one or both opposing major surfaces for directing reactants and/or coolant fluids to specific portions of such major surfaces. The open channels also provide passages for the removal of reaction products, depleted reactant streams, and/or heated coolant streams. For an illustration of a fluid flow field plate, see, for example, U.S. Pat. No. 4,988,583. Where the major surface of a fluid flow field plate faces an MEA, the open channels typically direct a reactant across substantially all of the electrochemically active area of the adjacent MEA. Where the major surface of a fluid flow field plate faces another flow field plate, the channels formed by their cooperating surfaces may be used for carrying a coolant for controlling the temperature of the fuel cell.

Some early experimental fuel cell fluid flow field plates incorporated straight flow field channels. These early flow field plates were generally made from rigid, suitably electrically conductive materials, such as, for example, composites comprising resin and graphite or carbon fibers. The flow field channels were typically milled using a cutting tool. These materials and the milling procedure limited the size and shape of conventional flow field channels. Early experimental fluid flow field plates were used in experimental fuel cells operating at lower current densities (i.e., typically less than about 380 milliamps per square centimeter (mA/cm²)). However, early experimental fluid flow field plates of this type yielded poor performance when used in fuel cells operated at higher current densities, such as, for example, higher than about 500 mA/cm². Present day fuel cells may operate at even higher current densities, such as, for example, higher than 1000 mA/cm².

A factor that contributes to the observed poor performance is poor water management within fuel cells using conventional straight flow field channels. An increase in current density typically results in, inter alia, a corresponding increase in the rate of production of reaction product water. If reaction product water accumulates within the reactant flow field channels, the water may prevent the reactants from accessing the electrocatalyst at the membrane-electrode interface, causing a decrease in fuel cell performance.

Furthermore, a problem with conventional straight path fluid flow channels may be the relatively large cross-sectional area of channels. One objective of early experimental fuel cells was to reduce pressure losses in the flow field to reduce parasitic energy demands of the reactant stream delivery devices. The aforementioned conventional milling methods also precluded the fabrication of channels with smaller cross-sectional areas because milling methods are impractical for producing fluid flow field plates with channel widths less than 0.75 millimeter. For example, it is difficult to maintain consistent channel dimensions using conventional milling methods because the cutting tools wear down. For smaller channels, variations in channel dimensions caused by cutting tool wear can be significant, whereas for larger channels, the same magnitude of variation is less significant when the variations in cross sectional area are considered as a percentage of the total cross sectional area. A consequence of the milled flow field channels is that, because of the channel size, they are more prone to obstruction by reaction product water in the fuel cell because the fluid velocity is lower and the pressure differential between the channel inlet and outlet is less.

Increasing the pressure differential (i.e., the pressure drop) between a reactant flow field channel inlet and outlet may be used to reduce or eliminate the accumulation of product water; see, for example, U.S. Pat. Nos. 5,260,143, 5,366,818, and 5,441,819 which are hereby incorporated by reference in their entirety. However, higher pressure differentials must be balanced against larger parasitic energy demands.

One approach to increasing the pressure differential is to increase the length of the channels. However, because of the relatively large cross-sectional area of conventional milled straight channels, to produce a sufficiently large pressure differential, the fluid flow field channel would need to be extremely long or the fluid flow rate would need to be dramatically increased. For example, the following table shows theoretical calculations of the channel length for conventional channels with a width and depth of 0.75 mm. These calculations show that, to obtain a pressure drop of about 200 mbar using conventional channels, the channel length must be about 1200 millimeters long (i.e. requiring a electrochemically active area with a length of about 1200 millimeters).

### EXAMPLE A

| Parameter | Value |
|---|---|
| Electrochemically Active | 300 cm² |
| Area | |
| Power Density | 1000 mA/cm² |
| Fluid | Air |
| Stoichiometry | 1.5 |
| Width of Lands Between | 0.5 millimeter |
| Channels | |
| Flow Field Flow Rate | 7.54 liters/minute |
| Flow Rate For Single | 0.377 |
| Channel | liters/minute |
| Number of Channels | 20 |
| Channel Length | 1200 millimeters |
| Channel Cross-Sectional | 0.563 mm² |
| Area | |
| Width of Channel Area | 25 millimeters |
| Ratio of Channel Length to | 2133:1 |
| Channel Cross-Sectional | |
| Area | |
| Ratio of Length to Width | 48:1 |
| For Channel Area | |

In Example A, the channel length of 1200 millimeters results in a length to width ratio for the electrochemically active area of about 48:1. Conventional fuel cell plates have not typically employed such extremely elongated flow field plates. One reason for avoiding such elongated plates relates to their structural properties. Another reason is that such shapes have a much higher ratio between the perimeter and the area. Seals are generally located around the perimeter of a fluid flow field plate to prevent leakage of the fuel cell fluids, such as, the reactants and coolants. By reducing the perimeter length, the plate area occupied by seals is reduced, allowing the fuel cell to be made smaller and/or a larger percentage of the area to be allocated for the electrochemically active area. With reference to Example A, for a channel area width of 25 millimeters and a channel length of 1200 millimeters, the perimeter of the channel area is 2450 millimeters. Assuming that the sealing area is about 3 millimeters wide, the sealing area needed to surround the channel area will about 7350 mm², which is almost 25 percent of the electrochemically active area. Reducing the length by half while preserving the same electrochemically active area (i.e. a channel area width of 50 millimeters and a channel length of 600 millimeters) reduces the channel area perimeter to 1300 millimeters and the corresponding sealing area to 3900 mm² (i.e., about 13 percent of the electrochemically active area). Accordingly, reducing seal area results in a higher power density. Therefore, to reduce the plate area required for seals, conventional fuel cells have typically been made more square or round, rather than elongated.

Instead of fabricating extremely elongated straight fuel cell channels, another approach to increasing the pressure differential without reducing the channel cross-sectional area is to employ serpentine channels; see for example U.S. Pat. Nos. 4,988,583 and 5,108,849, which are hereby incorporated by reference in their entirety. With a serpentine channel, the bends cause a pressure drop, and the channel length may be increased without requiring a fluid flow field plate with a dimension as long as the channel.

However, there are several advantages associated with substantially straight channels. For example, one advantage is that, compared to non-linear channels where there may be eddies near bends in the channel, straight channels provide less places for water to accumulate in the channels. Another advantage is that there is less turbulence in fluids flowing in the channels since there are no corners. Turbulent fluid flow may eventually damage fuel cell components, reducing the reliability and service life of the fuel cell. Also, if the fuel cell employs a plurality of parallel straight channels, every channel on the plate may easily be made with exactly the same length, which may not necessarily be true for channels that follow a serpentine or tortuous path.

Another advantage of substantially straight channels is that there tends not to be a substantial pressure differential between adjacent channels. A pressure differential between adjacent channels may result in fluids short-circuiting or by-passing of certain channel portions, particularly at the channel corners, in non-linear channels, where the fluid may traverse the land to an adjacent channel which has a lower fluid pressure. Fluid flow field plates employing a plurality of parallel serpentine channels also may have a pressure differential between adjacent channels.

Another problem with channel corners in channels having sloped side walls is that they are especially susceptible to undesirably deflecting the fluid stream out of the channel, into the adjacent electrode, and across the adjacent land area. This is one of the reasons why conventional channels have typically employed side walls that are perpendicular to the major surface of the adjacent MEA.

Yet another advantage of straight channels relates to temperature control in the fuel cell. The temperature gradient across the fuel cell may be controlled so that, for example, the temperature increases in the direction of the oxidant flow direction. Non-linear channels may produce a channel pattern wherein adjacent channels have conflicting temperature requirements, upsetting the temperature control along the channel. The temperature gradient, in combination with a pressure differential between the channel inlet and outlet, may be advantageously used to control the relative humidity of the oxidant stream, and thereby improve the removal of excess water from within the fuel cell. With substantially straight channels the oxidant and coolant channels may be parallel and the oxidant and coolant may flow in the same direction.

Accordingly, there are numerous potential advantages of conventional fluid flow field plates that employ straight channels. However, heretofore, fluid flow field plates using conventional straight channels have provided satisfactory performance at low current densities, but have been unable to provide satisfactory performance at higher current densities. Current density is defined as the number of milliamps per square centimeter of electrochemically active area. In the context of this disclosure, “high” current density is defined as current densities of 500 mA/cm² and higher. In this context, performance may be measured by measuring the cell voltage at a particular current density, wherein at a given current density, higher cell voltage signifies higher performance. An improved fluid flow field plate that incorporates substantially straight channels provides improved performance at high current densities compared to conventional fluid flow field plates.

### SUMMARY OF THE INVENTION

In one embodiment, an electrically conductive, fuel cell fluid flow field plate comprises:

(a) a first major surface;

(b) a second major surface, opposite to the first major surface; and

(c) at least one substantially straight channel formed in the first major surface, wherein at least one channel has an open width less than about 0.75 millimeter and a length which extends substantially between two opposing edges of the fluid flow field plate.

The preferred fuel cell is a solid polymer fuel cell. The fluid flow field plate preferably comprises a plurality of substantially straight parallel channels separated by lands. Each of the plurality of substantially straight channels preferably has an open width less than about 0.75 millimeter and extends substantially between two opposing edges of the fluid flow field plate. Each one of the plurality of channels preferably has about the same length. There may be some variation in the length of fluid passages for fluidly connecting each of the channels to a manifold. Non-linear fluid passages or flow guides may be employed to direct the fluid from the substantially straight channels to the manifolds. In operation, the pressure drop in the substantially straight channels is relatively large, compared to the pressure drop in the non-linear passages, so any differences in the pressure are insignificant between each one of the plurality of substantially straight channels.

A preferred fluid flow field plate has an open width of about 0.5 millimeter for each one of the plurality of substantially straight channels. The channel may have a semicircular cross-section with a radius of about 0.25 millimeter.

The lands may comprise a substantially flat surface parallel to the plane of the first major surface. These lands may have rounded edges with a radius of curvature of at least 0.15 millimeter next to adjacent ones of the channels. Alternatively, the lands may comprise a convex ridge. The shape of the lands is formed so as to provide a surface that may be pressed against the relatively thin and fragile MEA without causing any damage to it. Accordingly, lands with sharp profiles are undesirable. Further, it is undesirable for lands bearing against opposing side of the MEA to be offset so as to apply shear forces to the MEA. In a preferred embodiment, the lands have a flat surface with a width between about 0.5 millimeter and 0.9 millimeter.

Thin fluid flow field plates are desirable to improve the power density of a fuel cell or fuel cell stack. A preferred flow field plate has a maximum overall thickness of about 0.8 millimeter between the first and second major surfaces. Fluid flow field plates with channels formed on both opposing major surfaces may have a thickness of about 1.1 millimeter for channels which have depths of 0.25 millimeter on one major surface, and about 0.4 millimeter on the opposing major surface. To provide adequate structural strength, the fluid flow field plate has an absolute minimum web thickness of between about 0.35 and 0.6 millimeter. Preferably the web thickness is designed to be at least 0.4 millimeter to allow for tolerance variations during manufacturing.

The channels preferably have a depth that is approximately half of the channel open width. For example, for a channel with an open width of about 0.8 millimeter, the maximum channel depth may be about 0.4 millimeter (i.e. for a semicircular channel cross-section, the radius curvature is about 0.4 millimeter).

Fuel cell fuel stream flow rates are generally lower than oxidant stream flow rates. Accordingly, compared to oxidant channels, smaller channels may be generally employed for fuel channels. For example, in a fuel cell, if substantially straight oxidant channels with a semicircular cross-section have an open width of about 0.84 millimeter, corresponding substantially straight fuel channels with a semicircular cross-section and an open width of about 0.5 millimeter may be employed.

Channels with cross-sectional shapes other than semicircles may also be employed. For example, the channel may have a flat base and opposing side walls that diverge outwardly from the base towards the open width. An advantage of outwardly diverging side walls is that this feature facilitates forming the plate by molding or embossing.

The fluid flow field plate may comprise expanded graphite, being formed, for example, from flexible graphite foil, which may be formed into a plate by roller embossing methods. After embossing, the plate may be impregnated with a low viscosity thermosetting resin.

In another embodiment, an electrically conductive, fuel cell fluid flow field plate comprises:

(a) a first major surface;

(b) a second major surface, opposite to the first major surface; and

(c) a plurality of parallel, substantially straight channels formed in at least one of the first and second major surfaces, wherein at least one of the plurality of channels has a length to cross-sectional area ratio of between about 2180:1 to about 6200:1.

A preferred fluid flow field plate has a plurality of channels that each have a length to cross-sectional area ratio of about 2190:1. In another preferred embodiment, the fluid flow field plate has a plurality of channels that each have a length to cross-sectional area ratio of about 6180:1. A larger length to cross-sectional area ratio may be employed for lower flow rates across the fluid flow field plate, to accomplish the desired pressure drop.

The fluid flow field plate preferably has a plurality of channels that define a channel area that corresponds to the electrochemically active area of the MEA interposed between respective oxidant and fuel channel areas. The preferred channel area has a length to width ratio greater than about 3:1 and less than about 48:1. For example, a preferred channel area has a length to width ratio is about 12:1.

The following table illustrates two preferred embodiments of a fluid flow field plate having channel areas that have length to width ratios within the preferred range. Example 1 assumes a higher flow rate than Example 2, as might be the case if, for example, Example 1 related to oxidant channels and Example 2 related to fuel channels. The tables also show that in these examples, the ratio between the channel length and the cross-sectional area is also within the desired range:

### EXAMPLE 1

| Parameter | Value |
|---|---|
| Electrochemically Active | 300 cm² |
| Area | |
| Power Density | 1000 mA/cm² |
| Fluid | Air |
| Stoichiometry | 1.5 |
| Width of Lands Between | 0.5 millimeter |
| Channels | |
| Flow Field Flow Rate | 7.54 liters/minute |
| Flow Rate For Single | 0.203 |
| Channel | liters/minute |
| Pressure Drop | approx. 200 mbar |
| Number of Channels | 37 |
| Channel Length | 600 millimeters |
| Channel Cross-Sectional | 0.277 mm² |
| Area | |
| Width of Channel Area | 50 millimeters |
| Ratio of Channel Length to | 2166:1 |
| Channel Cross-Sectional | |
| Area | |
| Ratio of Length to Width | 12:1 |
| For Channel Area | |

### EXAMPLE 2

| Parameter | Value |
|---|---|
| Electrochemically Active | 300 cm² |
| Area | |
| Power Density | 1000 mA/cm² |
| Fluid | Reformate (69% H₂) |
| Stoichiometry | 1.2 |
| Width of Lands Between | 0.84 millimeter |
| Channels | |
| Flow Field Flow Rate | 3.65 liters/minute |
| Flow Rate For Single | 0.10 liters/minute |
| Channel | |
| Pressure Drop | approx. 345 mbar |
| Number of Channels | 36 |
| Channel Length | 600 millimeters |
| Channel Cross-Sectional | 0.098 mm² |
| Area | |
| Width of Channel Area | 50 millimeters |
| Ratio of Channel Length to | 6184:1 |
| Channel Cross-Sectional | |
| Area | |
| Ratio of Length to Width | 12:1 |
| For Channel Area | |

In Example 1, the channels have an open width of about 0.84 millimeter and a semicircular cross sectional shape. In Example 2, the channels have an open width of about 0.5 millimeter and a semicircular cross sectional shape. Examples 1 and 2 show that, compared to Example A, smaller channel cross-sectional areas enable fluid flow field plates to employ shorter straight channel lengths so that the ratio of length to width for the electrochemically active area may be reduced. These advantages could not be realized by fluid flow field plates employing conventional milled channels with larger cross-sectional areas, such as the channels of Example A.

A corresponding electrochemical fuel cell comprises:

(a) a fuel flow field plate with opposing first and second major surfaces;

(b) an oxidant flow field plate with opposing first and second major surfaces;

(c) a membrane electrode assembly interposed between the first major surfaces of the fuel and oxidant flow field plates; and

(d) at least one substantially straight fuel channel formed in the first major surface of the fuel flow field plate,

wherein the fuel channel has an open width less than 0.75 millimeter and a length which extends substantially between two opposing edges of the fluid flow field plate.

A plurality of fluid flow field plates as described herein may be employed in the electrochemical fuel cell. That is, the electrochemical fuel cell may comprise a plurality of parallel straight oxidant channels formed in the first major surface of the oxidant flow field plate. The plurality of oxidant channels may extend from an oxidant inlet to an oxidant outlet, wherein at least one of the plurality of oxidant channels has an open width of about 0.85 millimeter or less. The plurality of fuel channels may be oriented parallel to the plurality of oxidant channels.

The spacing of the channels may be arranged to avoid applying shear forces to the MEA. For example, to avoid lands on the oxidant flow field plate from being positioned within the channels on the fuel flow field plate, the spacing between the centers of the oxidant channels may be made the same as the spacing between the centers of the fuel channels. That is, if the fuel channels have a width of 0.5 millimeter, and the oxidant channels have a width of 0.84 millimeter, the lands between adjacent oxidant channels may have a width of about 0.5 millimeter, and the lands between adjacent fuel channels may have a width of about 0.84 millimeter. In this way, the lands on the respective fuel and oxidant flow field plates may be aligned so that a land area is never unsupported on the opposite side of the MEA by being aligned with an opposite channel. In one embodiment, the center of each of the plurality of fuel channels is aligned with the center of one of the plurality of oxidant channels.

When the fuel cell is one of a plurality of fuel cells arranged in a stack, coolant channels may be provided between the second major surfaces of adjacent ones of the fuel and oxidant flow field plates. That is, channels formed in at least one of the second major surfaces, and the opposing second major surface of an adjacent fuel cell cooperate to form coolant passages.

In an electrochemical fuel cell stack, the fuel cells are preferably oriented such that the oxidant and fuel channels are substantially horizontal. In this embodiment, liquids such as water, which may accumulate within the channels, may drain in the direction of the fluid flow. That is, there are no low points in the channel where water may collect. Because the channels are straight and substantially horizontal, water may drain in whichever direction the fluid in the channel is flowing.

In one embodiment of the electrochemical fuel cell, the oxidant and fuel channels have a length of about 600 millimeters.

The electrochemical fuel cell preferably further comprises internal fuel and oxidant internal manifolds formed by aligned and fluidly sealed openings provided in the fuel flow field plate, the oxidant flow field plate and the membrane electrode assembly. In a preferred embodiment, the flow field plates are arranged with the first and second major surfaces in a substantially vertical plane with the fuel and oxidant manifolds extending substantially horizontally through the stack. The fuel and oxidant manifolds preferably each have a low point that is lower than a lowest one of the corresponding fuel and oxidant channels.

Another preferred electrochemical fuel cell comprises:

(a) a fuel flow field plate with opposing first and second major surfaces;

(b) an oxidant flow field plate with opposing first and second major surfaces;

(c) a membrane electrode assembly interposed between the first major surfaces of the fuel and oxidant flow field plates;

(d) a plurality of parallel substantially straight fuel channels formed in the first major surface of the fuel flow field plate, the fuel channels extending from a fuel inlet to a fuel outlet; and

(e) a plurality of parallel substantially straight oxidant channels formed in the first major surface of the oxidant flow field plate, the oxidant channels extending from an oxidant inlet to an oxidant outlet;

wherein there is a pressure differential between the inlets and outlets of the oxidant and fuel channels of between about 138 millibars and about 400 millibars when the fuel cell is operating at a current density higher than about 500 mA/cm².

A method of making a fluid flow field plate as described herein comprises:

(a) providing a sheet of compressible, electrically conductive sheet material having two oppositely facing major surfaces; and

(b) embossing the first major surface to form the at least one open-faced channel.

The embossing method is particularly suited to forming channels with open widths less than 0.75 millimeter. Expanded graphite may be employed as one of the materials for forming the fluid flow field plates. For high speed manufacturing, a roller embossing machine may be employed to emboss a sheet of expanded graphite. The roller embossing machine may further comprise cutters mounted on a roller for cutting the sheet to a desired shape. The method may further comprise forming at least one opening in the sheet and forming a fluid passage between the opening and the channel. The embossed plate preferably has a minimum web thickness of between 0.35 millimeter and 0.6 millimeter. After embossing, the plate may be impregnated with a low viscosity thermosetting resin.

Another method of making the fluid flow field plate described herein comprises:

(a) providing a mold for forming the plate wherein the mold provides channels on a major surface of the plate and sealing areas which circumscribe an area defined by the channels;

(b) depositing an electrically conductive material into the mold;

(c) molding the electrically conductive material until it is molded into the shape defined by the mold; and

(d) removing a molded plate from the mold.

The electrically conductive material employed by the molding method may be a composite material comprising carbon or graphite. The material may comprise a thermosetting and/or a thermoplastic resin.

Different types of molding methods may be used to form the fluid flow field plate. For example, the molding method may be a compression molding process or an injection molding process.

### BRIEF DESCRIPTION OF THE DRAWINGS

The advantages, nature and additional features of the invention will become more apparent from the following description, together with the accompanying drawings, which illustrate specific embodiments of the fluid flow field plates of the present invention.

FIG. 1 is a partial cross-sectional view of a fuel cell that depicts a membrane electrode assembly interposed between an oxidant fluid flow field plate and a fuel fluid flow field plate.

FIGS. 2A through 2D are examples of different embodiments of channel cross section shapes. In particular,

FIG. 2A depicts concave channels separated by convex land areas;

FIG. 2B depicts semi-circular channels separated by flat land areas with rounded edges;

FIG. 2C depicts a trapezoid flow field channel also separated by flat land areas; and

FIG. 2D depicts a trapezoid channel with rounded corners and land edges.

FIG. 3A is a plan view of an oxidant fluid flow field plate, depicting oxidant channels formed in the major surface of the plate which faces the cathode of the membrane electrode assembly when incorporated into a fuel cell assembly.

FIG. 3B is a side elevation view of the oxidant fluid flow field plate of FIG. 3A.

FIG. 3C is a plan view of the oxidant fluid flow field plate of FIG. 3A, depicting the major surface of the plate which faces away from the membrane electrode assembly, that is, the major surface of the plate which is opposite the major surface of FIG. 3A.

FIG. 4A is a plan view of a fuel fluid flow field plate, depicting fuel channels formed in the major surface of the plate which faces the anode of the membrane electrode assembly when the plate is incorporated into a fuel cell assembly.

FIG. 4B is a side elevation view of the fuel flow field plate of FIG. 4A.

FIG. 4C is a plan view of the fuel fluid flow field plate of FIG. 4A, depicting coolant fluid flow field channels formed in the major surface which faces away from the membrane electrode assembly, that is, the major surface of the fuel flow field plate which is opposite the major surface of FIG. 4A.

With reference to all of the FIGURES, like numbers are used to denote like components.

### DETAILED DESCRIPTION OF PREFERRED EMBODIMENT(S)

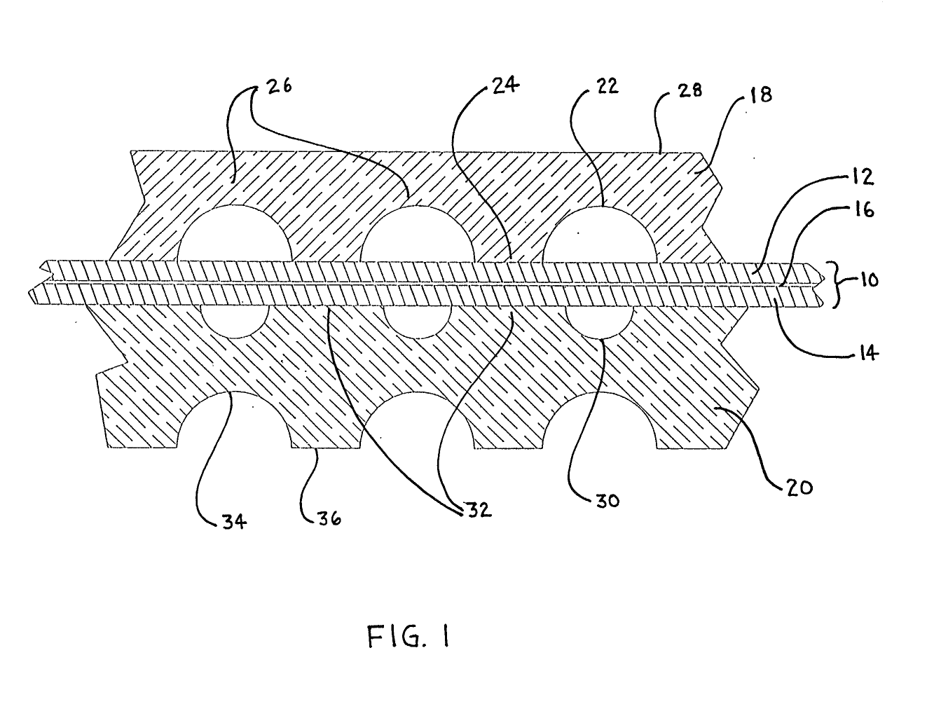

FIG. 1 illustrates a partial cross sectional view of a solid polymer fuel cell. MEA 10 comprises a cathode 12, an anode 14, and a solid polymer electrolyte 16 interposed therebetween. The thickness of MEA 10 in the assembled cell is less than 0.35 millimeter. MEA 10 is interposed between oxidant flow field plate 18 and fuel flow field plate 20 to form a fuel cell assembly. Oxidant and fuel flow field plates 18 and 20 each have two parallel major surfaces with a respective one of these major surfaces facing and contacting MEA 10 to provide support and electrical contact.

Oxidant channels 22, separated by lands 24, are formed in the major surface of oxidant flow field plate 18, which faces MEA 10. In the illustrated embodiment, oxidant channels 22 have a semi-circular cross section and lands 24 have substantially flat surfaces parallel to the plane of the major surfaces of oxidant flow field plate 18. In a preferred embodiment, oxidant channels 22 have an open width of about 0.84 millimeter and the lands 24 have a width of about 0.50 millimeter. The oxidant flow field plate may have a thickness of about 0.82 millimeter, such that the thinnest portion of oxidant flow field plate 18 is about 0.40 millimeter thick (i.e., in the illustrated embodiment, the thinnest portion of flow field plate 18 is web portion 26 which is between flat major surface 28 and the deepest part of oxidant channel 22).

Fuel channels 30, separated by lands 32, are formed in the major surface of fuel flow field plate 20 which faces MEA 10. In the illustrated embodiment, fuel channels 30 have a semi-circular cross section and lands 32 have substantially flat surfaces parallel to the plane of major surfaces of fuel flow field plate 20. In the illustrated embodiment, the centers of fuel channels 30 are aligned with the centers of opposite oxidant channels 22. An advantage of this arrangement is that the oxidant and fuel channel edges are spaced so that they do not exert shear forces on MEA 10, which may damage MEA 10. In a preferred embodiment, fuel channels 30 have an open width of about 0.50 millimeter and the lands have a width of about 0.84 millimeter.

Fuel flow field plate 20 also has coolant channels 34 formed in major surface 36. The illustrated fuel cell assembly may be one of a plurality of fuel cell assemblies arranged in a stack. When the fuel cell assemblies are stacked one on top of the other, major surface 36 and coolant channels 34 cooperate with major surface 28 of an adjacent fuel cell assembly to form a plurality of coolant passages therebetween. Coolant channels 34 may be formed in either major surface 28 or in major surface 36 (as illustrated). In the illustrated embodiment, coolant channels 34 are semi-circular, have an open width of about 0.84 millimeter, and are also aligned with reactant channels 22, 30.

Preferably, the coolant channels are formed in fuel flow field plate 20 (as illustrated) because fuel channels 30 are generally smaller than oxidant channels 22. Thus, by forming coolant channels in fuel flow field plate 20, the oxidant and fuel flow field plates are closer in thickness. In the illustrated example, fuel flow field plate 20 may have a thickness of about 1.07 millimeters with a web thickness of about 0.4 millimeter (i.e., for the illustrated fuel flow field plate 20, the thickness of the plate between the deepest points of fuel channel 30 and coolant channel 34 is about 0.4 millimeter. Alternatively, the thickness of fuel flow field plate 20 may be reduced by offsetting fuel channels 30 from coolant channels 34. For example, fuel channel 30 may be aligned with land 36 and coolant channel 34 may be aligned with land 32. In another embodiment, a corrugated material may be employed to provide channels on opposite major surfaces of a fluid flow field plate.

The fuel and oxidant channels direct reactants across and through the porous electrodes to the electrocatalyst at the membrane electrode interface. Accordingly, a large open channel area is desirable. That is, a large percentage of the major surface of the fluid flow field plate is preferably open channel area. An advantage of straight channels is that thinner land areas may be employed between adjacent channels because there are no pressure differentials between adjacent channels (i.e. no danger of short circuiting), no bends, and, because there are no adjacent channels where a fluid is flowing in opposite directions on the same fluid flow field plate.

The fluid distribution function of the flow field channels must be balanced against the structural function of the land areas, which is to support the MEA. The thickness and rigidity of the MEA limits the width of the channels, since the MEA may deflect into the channels if the channel widths are too wide. As shown in FIG. 1, an advantage of straight channels is that the land areas 24 and 32 may be aligned so that the opposing land areas do not exert any shear forces on the MEA. Further, the land areas should not be too thin, so that they act as a sharp peak that might cut into the MEA. In addition to the structural support function, another important function of the land areas is to provide adequate thermal and electrical conductivity by providing a sufficiently large surface area in contact with the MEA.

Coolant channels have different functional requirements from the fuel and oxidant channels. Coolant channels are preferably shaped and sized to reduce parasitic losses (i.e. by reducing pressure losses), and to improve thermal contact between the coolant and the fuel cell plates.

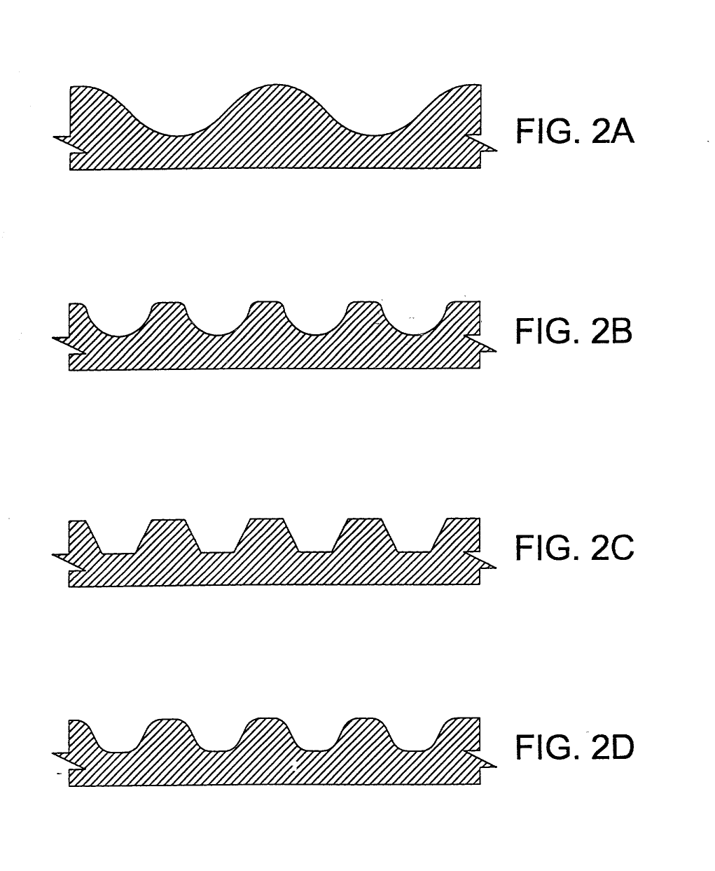

FIG. 1 illustrates a fuel cell assembly wherein all of the fluid flow field channels are semi-circular and separated by substantially flat land areas. FIGS. 2A through 2D show examples of other channel cross section shapes that may be employed for oxidant, fuel, or coolant channels. Additionally, a fuel cell assembly may employ more than one channel shape. For example, the coolant channels may be shaped and sized differently from the fuel and/or oxidant channels.

FIG. 2A depicts concave channels separated by convex land areas. The convex shape of the land areas is less likely to damage an MEA. The convex shape also widens the open area of the channel, facilitating the distribution of fuel or oxidant to the adjacent electrode areas.

FIG. 2B depicts substantially semi-circular channels separated by substantially flat land areas with rounded edges. The rounded edges are easy to form by embossing or molding methods. The rounded edges also eliminate sharp edges, while the flat land area provides good thermal and electrical contact between the flow field plate and the MEA.

FIG. 2C depicts trapezoidal flow field channels with each channel having a flat base and sloped side walls. FIG. 2D illustrates an embodiment with substantially flat land areas and a substantially flat channel base that is similar to the embodiment of FIG. 2C except that the edges are rounded. Compared to vertical side walls, sloped side walls are easier to form by embossing and molding methods. Those skilled in the art will readily recognize that other channel and land shapes, not illustrated, such as v-shapes or half-octagons, may also be used.

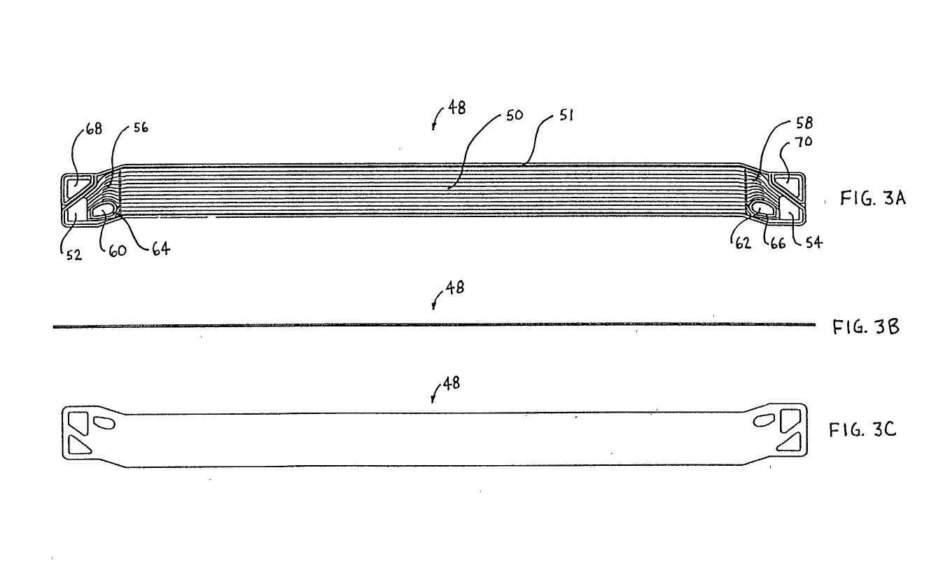

FIGS. 3A through 3C illustrate three different views of a preferred embodiment of an oxidant flow field plate 48. FIG. 3A is a plan view of a first major surface of oxidant flow field plate 48 comprising a plurality of parallel substantially straight oxidant channels 50. Perimeter seal area 51 circumscribes the oxidant channel area and through plate openings which may serve as fluid manifold segments. Seals may comprise gaskets, molded elastomers, and the plate material itself that cooperates with perimeter seal area 51 to form a fluid seal. In the absence of a fluid leak, these seals confine the oxidant fluid to the circumscribed area of oxidant flow field plate 48.

In the illustrated embodiment, there are oxidant manifold openings 52 and 54 associated with opposite ends of oxidant channels 50. Oxidant passages 56 direct the oxidant between oxidant manifold opening 52 and oxidant channels 50. Similarly, oxidant passages 58 direct the oxidant between oxidant manifold opening 54 and oxidant channels 50. Oxidant flow field plate 48 provides fuel manifold openings 60 and 62 and respective perimeter seals 64 and 66 for fluidly isolating oxidant passages 56 and 58 from the fuel fluid stream transported through the fuel manifolds. Oxidant flow field plate 48 also provides coolant manifold openings 68 and 70 which also have perimeter seals to fluidly isolate oxidant passages 56 and 58 from the coolant fluid stream.

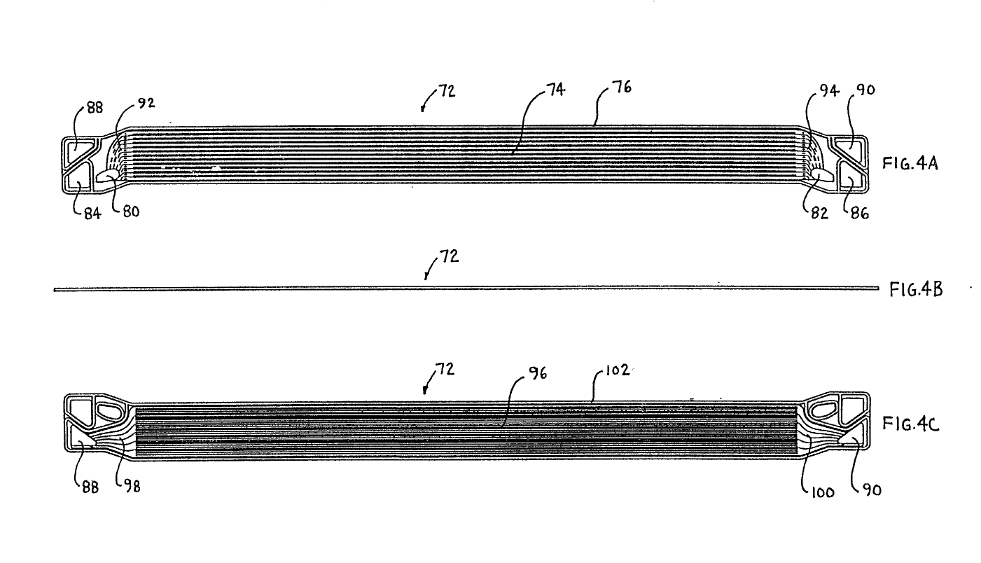

In FIG. 3A, the illustrated embodiment of oxidant flow field plate 48 has an overall length of about 734 millimeters and an overall width of about 64 millimeters. Straight oxidant channels 50 are about 606 millimeters long. Straight oxidant channels 50 and separating land areas occupy an area of about 300 square centimeters, which generally corresponds to the area of a fuel cell MEA electrochemically active area which would be disposed between the oxidant and fuel flow field plates of FIGS. 3A and 4A. However, those skilled in the art will recognize that MEAs may be fabricated with a variety of areas and shapes. For example, a larger MEA area may be accommodated by adding to the width of the fluid flow field plates, and adding to the number of straight oxidant and fuel channels. However, in the preferred embodiment, increasing the MEA area does not change the characteristics of the flow field channels, such as, for example, the width of the channels, or the ratio between the channel length and the channel cross-sectional area, or the pressure drop from the channel inlet to the channel outlet when the flow field plates are used in a fuel cell which is operating with a current density of 500 mA/cm² or higher.

FIG. 3B is a side elevation view of oxidant flow field plate 48. In the illustrated embodiment, the thickness of oxidant flow field plate may be as thin as about 0.82 millimeter and the first major surface defines a planar surface which is parallel to the planar surface of the opposing second major surface. The desire to make the oxidant flow field plates thin to increase power density, must be balanced against the structural requirements of the fluid flow field plate. The fluid flow field plates must not be made so thin as to compromise dimensional stability, strength, or other structural properties. For fluid flow field plates made from expanded graphite, a web thickness of about 0.35 millimeter may be employed, but a web thickness of about 0.4 millimeter is preferred to provide a suitable allowance for tolerance variations which may arise in the manufacturing process.

FIG. 3C is a plan view of a second major surface of oxidant flow field plate 48. In the illustrated embodiment, the second major surface is substantially planar. Thus, the factors which determine the thickness of illustrated oxidant flow field plate 48 are the depth of oxidant channels 50 and the web thickness measured at the deepest point in oxidant channels 50.

FIG. 4A is a plan view of a first major surface of fuel flow field plate 72 comprising a plurality of parallel substantially straight fuel channels 74. Perimeter seal 76 circumscribes the fuel channel area and through plate openings which may serve as fluid manifolds. In the absence of a fluid leak, seals associated with perimeter seal area 76 confine the fuel to the area circumscribed by perimeter seal area 76 of fuel flow field plate 72.

To form a fuel cell assembly, an MEA may be interposed between the first major surface of oxidant flow field plate 48 (illustrated in FIG. 3A), and the first major surface of fuel flow field plate 72 (illustrated in FIG. 4A). The membrane of the MEA is substantially impermeable to oxidant and fuel, so in the absence of a leak in the membrane, the MEA cooperates with perimeter seals 51 and 76 to fluidly isolate the oxidant from the fuel.

Since oxidant flow field plate 48 and fuel flow field plate 72 cooperate with one another, their respective major surfaces are similar in size and shape. Manifold openings shown in FIGS. 4A and 4C align with the manifold openings shown in FIGS. 3A and 3C. That is, fuel manifold openings 60 and 62 of oxidant flow field plate 48 align with fuel manifold openings 80 and 82 of fuel flow field plate 72. Oxidant manifold openings 52 and 54 of oxidant flow field plate 48 align with oxidant manifold openings 84 and 86 of fuel flow field plate 72. Finally, coolant manifold openings 68 and 70 of oxidant flow field plate 48 align with coolant manifold openings 88 and 90 of fuel flow field plate 72. In a fuel cell stack, the manifold openings collectively form fluid manifolds for supplying and exhausting respective oxidant, fuel, and coolant fluid streams to each fuel cell assembly.

Fuel channels 74 extend substantially between two opposing edges of fuel flow field plate 72. Fuel passages 92 and 94 provide a path for fuel to flow between fuel channels 74 and respective fuel manifold openings 80 and 82. The fuel channel area, like the oxidant channel area, corresponds to the area of the MEA. Thus, straight fuel channels 74 are about 606 millimeters long and, in the illustrated embodiment, the area occupied by straight fuel channels 74 is about 300 square centimeters. Fuel channels 74 preferably have a semi-circular cross sectional area with an open width of about 0.5 millimeter.

FIG. 4B is a side elevation view of fuel flow field plate 72. In the illustrated embodiment, the fuel channel depth is about 0.25 millimeter, so if a web thickness of 0.35 millimeter is employed, the thickness of fuel flow field plate 72 may be as thin as about 0.6 millimeter. However, as shown by FIG. 4C, the illustrated embodiment of fuel flow field plate 72 also comprises coolant channels 96. Coolant channels 96 are formed in the second major surface of fuel flow field plate 72. In the illustrated embodiment, the depth of coolant channels is about 0.42 millimeter and the web thickness is about 0.4 millimeter. Accordingly, the illustrated fuel flow field plate 72 has a thickness of about 1.07 millimeters.

As shown by FIG. 4C, which is a plan view of a second major surface of fuel flow field plate 72, coolant channels 96 are fluidly connected to coolant manifold openings 88 and 90 by respective coolant passages 98 and 100. A fuel cell assembly comprises an MEA interposed between an oxidant flow field plate and a fuel flow field plate. A fuel cell stack may be made by placing one fuel cell assembly on top of another fuel cell assembly. A fuel cell stack may comprise a plurality of fuel cell assemblies stacked one on top of the other. In such a fuel cell stack arrangement, the planar second major surface of oxidant flow field plate 48 cooperates with the second major surface of fuel flow field plate 72 to enclose coolant channels 96. In the absence of a leak, seals associated with perimeter seal area 102 confine the coolant to the area circumscribed by perimeter seal area 102.

An advantage of the preferred symmetrical arrangement of oxidant flow field plate 48 and fuel flow field plate 72 is that the oxidant or fuel flow direction can be reversed without affecting fuel cell performance. In a fuel cell stack, oxidant flow field plate 48 and fuel flow field plate 72 are preferably oriented so that the straight channels are substantially horizontal and the fuel cell plates are oriented with their major surfaces in a vertical plane. Compared, for example, to vertical channels or non-linear channels that may have some vertically oriented portions, the substantially horizontally oriented channels may readily drain water to manifolds on either side of the straight channels. In the illustrated embodiment, water drains in the direction of fluid flow to the associated manifold that serves as an exhaust manifold. To enhance water drainage, each reactant manifold opening has a low point that is lower than the lowest point of the fluidly connected channels. The oxidant flow field plate 48 and fuel flow field plate 72 illustrated in FIGS. 3 and 4 provide an offset manifold opening area to accommodate the oxidant manifold openings 52 and 54 and fuel manifold openings 80 and 82 which both have low points which are lower than the lowest oxidant and fuel channels. Accordingly, in fuel cell assemblies where fluid flow direction is periodically reversed, a symmetrical arrangement is preferred to facilitate the draining of water in both directions.

The fluid flow field plate is made from a suitably electrically conductive and substantially fluid impermeable material. Expanded graphite is a preferred material because it is sufficiently impervious to typical fuel cell reactants and coolants to fluidly isolate the fuel, oxidant, and coolant fluid streams from each other. In addition, expanded graphite is compressible and embossing processes may be used to form channels in one or both major surfaces of an expanded graphite sheet. For example, embossing processes may include roller embossing or stamping methods. Graphite is chemically unreactive in a fuel cell environment and, compared to other materials with similarly suitable properties, graphite is relatively inexpensive. After the embossing procedure, the expanded graphite is preferably impregnated with a resin to make the material more impervious to reactants and coolants. For example, a low viscosity thermosetting resin may be used to impregnate the embossed plate. Preferably, the impregnant also improves the structural rigidity of the fluid flow field plate.

The fluid flow field plate may also be made by molding processes. For example, a corrosion-resistant metal powder, a base metal powder plated with a corrosion resistant metal, or other chemically unreactive electrically conducting powders such as carbon, graphite or boron carbide may be mixed with a polymeric binder and deposited into a mold to produce an electrically conductive fluid flow field plate. For example, injection molding or compression molding methods are suitable for molding fluid flow field plates with channels having a width of 0.75 millimeter or less.

Suitable polymeric binders include thermoplastic resins suitable for injection molding such as Kynar, a trademark for polyvinylidene fluoride material manufactured by Penwalt. Typical composites include 70-90% high purity graphite powder and 30-10% of polyvinylidene fluoride.

As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

What is claimed is:

1. An electrically conductive, fuel cell fluid flow field plate comprising:
(a) a first major surface;
(b) a second major surface, opposite to said first major surface; and
(c) at least one substantially straight channel formed in said first major surface, wherein said at least one channel has an open width less than about 0.75 millimeter and a length that extends substantially between two opposing edges of said fluid flow field plate.

2. The fluid flow field plate of claim 1 wherein said fuel cell is a solid polymer fuel cell.

3. The fluid flow field plate of claim 1 wherein said plate comprises a plurality of substantially straight parallel channels separated by lands, wherein each of said plurality of channels has an open width less than about 0.75 millimeter and extends substantially between two opposing edges of said fluid flow field plate.

4. The fluid flow field plate of claim 3 wherein each one of said plurality of channels has about the same length.

5. The fluid flow field plate of claim 3 wherein each one of said plurality of channels having an open width of less than about 0.75 millimeter has an open width of about 0.5 millimeter.

6. The fluid flow field plate of claim 3 wherein each one of said lands comprises a substantially flat surface parallel to the plane of said first major surface.

7. The fluid flow field plate of claim 6 wherein said lands have rounded edges with a radius of curvature of at least 0.15 millimeter next to adjacent ones of said channels.

8. The fluid flow field plate of claim 3 wherein each one of said lands comprises a convex ridge.

9. The fluid flow field plate of claim 3 wherein at least one of said lands has a flat surface with a width between about 0.5 millimeter and 0.9 millimeter.

10. The fluid flow field plate of claim 3 wherein the thickness of said flow field plate is no greater than about 0.8 millimeter.

11. The fluid flow field plate of claim 9 wherein said at least one channel has a maximum depth of about 0.4 millimeter.

12. The fluid flow field plate of claim 3 further comprising at least one channel formed in said second major surface.

13. The fluid flow field plate of claim 11 wherein the thickness of said flow field plate is no greater than about 1.1 millimeters.

14. The fluid flow field plate of claim 12 wherein at least one of said plurality of parallel substantially straight channels has a depth of about 0.25 millimeter and said second channel has a depth of about 0.4 millimeter.

15. The fluid flow field plate of claim 3 wherein at least one of said plurality of parallel substantially straight channels has a substantially semicircular cross-sectional area with a radius less than about 0.4 millimeter.

16. The fluid flow field plate of claim 3 wherein at least one of said plurality of parallel substantially straight channels has a substantially semicircular cross-sectional area with a radius of less than about 0.25 millimeter.

17. The fluid flow field plate of claim 3 wherein at least one of said plurality of channels has a flat base and opposing side walls diverging outwardly from said base towards said open width.

18. The fluid flow field plate of claim 3 wherein said fluid flow field plate comprises expanded graphite.

19. The fluid flow field plate of claim 18 wherein said plate is impregnated with a resin.

20. The fluid flow field plate of claim 3 wherein said fluid flow field plate has a web thickness between about 0.35 millimeter and about 0.6 millimeter.

21. The fluid flow field plate of claim 3 wherein said fluid flow field plate has a web thickness of about 0.4 millimeter.

22. An electrically conductive, fuel cell fluid flow field plate comprising:
(a) a first major surface;
(b) a second major surface, opposite to said first major surface; and
(c) a plurality of parallel, substantially straight channels formed in at least one of said first and second major surfaces, wherein at least one of said plurality of channels has a length to cross-sectional area ratio of between about 2180:1 to about 6200:1.

23. The fluid flow field plate of claim 22 wherein each one of said plurality of channels has a length to cross-sectional area ratio of about 2190:1.

24. The fluid flow field plate of claim 22 wherein each one of said plurality of channels has a length to cross-sectional area ratio of about 6180:1.

25. The fluid flow field plate of claim 22 wherein said plurality of channels define a channel area having a length to width ratio greater than about 3:1 and less than 48:1.

26. The fluid flow field plate of claim 24 wherein said length to width ratio is about 12:1.

27. An electrochemical fuel cell comprising:
(a) a fuel flow field plate comprising:
(1) a first major surface;
(2) a second major surface, opposite to said first major surface; and
(3) at least one substantially straight channel formed in said first major surface, wherein said at least one channel has an open width less than about 0.75 millimeter and a length that extends substantially between two opposing edges of said fluid flow field plate.
(b) an oxidant flow field plate with opposing first and second major surfaces; and
(c) a membrane electrode assembly interposed between said first major surfaces of said fuel and oxidant flow field plates.

28. The electrochemical fuel cell of claim 27 wherein said at least one fuel channel is one of a plurality of parallel fuel channels separated by lands.

29. The electrochemical fuel cell of claim 28 wherein at least one of said plurality of fuel channels has a width of about 0.5 millimeter.

30. The electrochemical fuel cell of claim 28 wherein said membrane electrode assembly has a thickness of less than about 0.35 millimeter.

31. The electrochemical fuel cell of claim 28 further comprising a plurality of parallel straight oxidant channels formed in said first major surface of said oxidant flow field plate, and said plurality of oxidant channels extend from an oxidant inlet to an oxidant outlet, wherein at least one of said plurality of oxidant channels has an open width less than about 0.85 millimeter.

32. The electrochemical fuel cell of claim 31 wherein said plurality of fuel channels are oriented parallel to said plurality of oxidant channels.

33. The electrochemical fuel cell of claim 31 wherein each one of said plurality of oxidant channels has an open width of about 0.85 millimeter.

34. The electrochemical fuel cell of claim 31 wherein each of said lands separating adjacent ones of said plurality fuel channels, has a width of about 0.85 millimeter and wherein each of said lands separating adjacent ones of said plurality of oxidant channels has a width of about 0.5 millimeter.

35. The electrochemical fuel cell of claim 31 wherein the center of each of said plurality of fuel channels is aligned with the center of one of said plurality of oxidant channels.

36. The electrochemical fuel cell of claim 27 wherein said fuel cell is one of a plurality of fuel cells arranged in a stack and coolant channels are provided between said second major surfaces of adjacent ones of said fuel and oxidant flow field plates.

37. The electrochemical fuel cell of claim 36 wherein said coolant channels are formed in one of said second major surfaces of said fuel and oxidant flow field plates.

38. The electrochemical fuel cell of claim 31 wherein said fuel cell is oriented such that said oxidant and fuel channels are substantially horizontal for draining, in the direction of the fluid flow, liquids which may accumulate within said channels.

39. The electrochemical fuel cell of claim 31 wherein said oxidant and fuel channels have a length of about 600 millimeters.

40. The electrochemical fuel cell of claim 36 further comprising internal fuel and oxidant internal manifolds formed by aligned and fluidly sealed openings provided in said fuel flow field plate, said oxidant flow field plate and said membrane electrode assembly.

41. The electrochemical fuel cell of claim 40 wherein said fuel and oxidant manifolds extend substantially horizontally through said stack.

42. The electrochemical fuel cell of claim 41 wherein each one of said fuel manifolds has a low point which is lower than a lowest one of said fuel channels and each one of said oxidant manifolds has a low point which is lower than a lowest one of said oxidant channels.

43. An electrochemical fuel cell comprising:
(a) a fuel flow field plate comprising:
(1) a first major surface;
(2) a second major surface, opposite to said first major surface; and
(3) a plurality of parallel substantially straight fuel channels formed in said first major surface wherein said at least one channel has an open width less than about 0.75 millimeter and a length that extends substantially between two opposing edges of said fluid flow field plate, of said fuel flow field plate, said fuel channels extending from a fuel inlet to a fuel outlet;
(b) an oxidant flow field plate comprising:
(1) a first major surface;
(2) a second major surface, opposite to said first major surface; and
(3) a plurality of parallel substantially straight oxidant channels formed in said first major surface wherein said at least one channel has an open width less than about 0.75 millimeter and a length that extends substantially between two opposing edges of said fluid flow field plate, of said oxidant flow field plate, said oxidant channels extending from an oxidant inlet to an oxidant outlet;
(c) a membrane electrode assembly interposed between said first major surfaces of said fuel and oxidant flow field plates;
wherein operating said fuel cell at a current density greater than about 500 mA/cm² creates a pressure differential between the inlets and outlets of said oxidant and fuel channels of between about 138 millibars and about 400 millibars.

44. A method of making the fluid flow field plate of claim 1, said method comprising:
(a) providing a sheet of compressible, electrically conductive sheet material having two oppositely facing major surfaces; and
(b) embossing said first major surface to form said at least one open-faced channel.

45. The method of claim 44 wherein a roller embossing machine is used to emboss said sheet material.

46. The method of claim 45 wherein said roller embossing machine further comprises cutters mounted on a roller for cutting said sheet to a desired shape.

47. The method of claim 44 wherein said sheet comprises expanded graphite.

48. The method of claim 47 further comprising impregnating said sheet with a resin after embossing.

49. The method of claim 44 further comprising forming at least one opening in said sheet and forming a fluid passage between said opening and said channel.

50. The method of claim 44 wherein said embossing compresses said sheet such that the thinnest portions of said sheet have a web thickness of between about 0.35 millimeter and 0.6 millimeter.

51. A method of making the fluid flow field plate of claim 1, said method comprising:
(a) providing a mold for forming said plate wherein said mold provides channels on a major surface of said plate and sealing areas which circumscribe an area defined by said channels;
(b) depositing an electrically conductive material into said mold;
(c) molding said electrically conductive material until it is molded into the shape defined by said mold; and
(d) removing a molded plate from said mold.

52. The method of claim 51 wherein said electrically conductive material is a composite material comprising carbon or graphite.

53. The method of claim 51 wherein said molding process is a compression molding process.

54. The method of claim 51 wherein said molding process is an injection molding process.

55. The method of claim 54 wherein said electrically conductive material comprises a thermosetting resin.

56. The method of claim 54 wherein said electrically conductive material comprises a thermoplastic resin.
